(19) United States
(12) Patent Application Publication
(10) Pub. No.: US 2015/0065106 A1
(43) Pub. Date: Mar. 5, 2015

(54) LINKING USER EQUIPMENT CONTEXTS ASSOCIATED WITH THE SAME PHYSICAL DEVICE

(71) Applicant: QUALCOMM Incorporated, San Diego, CA (US)

(72) Inventors: Amer CATOVIC, Carlsbad, CA (US); Manoj M. Deshpande, San Diego, CA (US); Danlu Zhang, San Diego, CA (US)

(73) Assignee: QUALCOMM Incorporated, San Diego, CA (US)

(21) Appl. No.: 14/013,630

(22) Filed: Aug. 29, 2013

(51) Int. Cl. H04W 8/22; H04W 72/04; H04W 88/06; H04W 24/10

(52) U.S. Cl. CPC H04W 8/22; H04W 24/10; H04W 72/048; H04W 88/06
USPC 455/418

(57) ABSTRACT

A method, an apparatus, and a computer program product are provided. The apparatus may be configured to link user equipment contexts associated with same physical device. A network entity may determine a link between a first context and a second context of a user equipment, and may combine procedures related to the first and the second contexts when the first context and the second context are linked. The first context and the second context may be associated with a common international mobile equipment identity of the UE and different international mobile subscriber identities. A wireless device may maintain a first wireless communications link corresponding to a first subscription and a second wireless communications link corresponding to a second subscription. The wireless device may refrain from performing a first radio resource procedure in relation to the first subscription after performing a similar radio resource procedure in relation to the second subscription.

### BACKGROUND

1. Field

Aspects of the present disclosure relate generally to wireless communication systems, and more particularly, to management of wireless devices that support multiple subscriptions.

2. Background

Wireless communication networks are widely deployed to provide various communication services such as telephony, video, data, messaging, broadcasts, and so on. Such networks, which are usually multiple access networks, support communications for multiple users by sharing the available network resources. Examples of such networks may be based on the Universal Mobile Telecommunications System (UMTS), a third generation (3G) mobile phone technology supported by the 3rd Generation Partnership Project (3GPP). The UMTS Terrestrial Radio Access Network (UTRAN), which is the successor to Global System for Mobile Communications (GSM) technologies, currently supports various air interface standards, including Time Division—Synchronous Code Division Multiple Access (TD-SCDMA), and code division multiple access (CDMA) or one of its variants such as Wideband-Code Division Multiple Access (W-CDMA). UMTS also supports enhanced 3G data communications protocols, such as High Speed Packet Access (HSPA), which provides higher data transfer speeds and capacity to associated UMTS networks.

Some wireless devices can support multiple subscriptions. Each subscription may be associated with a subscriber identity module or subscriber identification module (SIM). A wireless device may be referred to by the term user equipment (UE), or by some other terminology. Some wireless devices may support two or more SIMs in a multi-SIM device. When a wireless device has two SIMs installed, and both SIMs are active at the same time, the network may consider the connections associated with the two SIMs as relating two separate devices. In particular, a “UE Context” is tied to an international mobile subscriber identity (IMSI), rather than to physical user equipment. As a result, multi-SIM devices may perform duplicate device-specific procedures and may suffer unnecessary increased power consumption and the network may suffer unnecessary signaling load.

### SUMMARY

In an aspect of the disclosure, methods, computer program products, and apparatus are provided. The apparatus may comprise a modem, an access terminal, an access point and/or a network entity.

In an aspect of the disclosure a method of managing multiple contexts for a wireless device includes the steps of determining a link between a first context of a UE and a second context of the UE at a network entity, and combining procedures related to the first and the second contexts when the first context and the second context are linked. The first context and the second context may be associated with a common international mobile equipment identity (IMEI) of the UE and different IMSIs.

In an aspect of the disclosure, combining procedures related to the first and the second contexts includes synchronizing procedures related to the different IMSIs.

In an aspect of the disclosure, combining procedures related to the first and the second contexts includes performing a device-specific procedure in relation to the first context, and refraining from performing the device-specific procedure in relation to the second context. A result of the device-specific procedure may be propagated between the first context and the second context. The procedures may include at least one radio resource procedure. In one example, the radio resource procedure may include a UE capability exchange. In another example, the radio resource procedure may include a handover of the UE between base stations. In another example, the radio resource procedure may include one or more of a tracking area update procedure, a location area update procedure, and a routing area update procedure.

In an aspect of the disclosure, combining procedures related to the first and second contexts may include initiating a measurement reporting procedure at the UE. The measurement reporting procedure may be adapted to minimize a drive tests procedure.

In an aspect of the disclosure, combining procedures related to the first context and the second context includes causing the UE to monitor pages corresponding to both the first context and the second context during a single paging occasion in a discontinuous reception (DRX) cycle.

In an aspect of the disclosure, assignment of resources for the first context and the second context are coordinated. The resources may be assigned based on a power constraint of the UE.

In an aspect of the disclosure, the first context and the second context are determined to be linked based on an information exchange between the network entity and another network entity, the information relating the first context and the second context to a unique identifier of the UE. The information exchanged between the network entity and another network entity may include information relating the first context and the second context transmitted in an attach or registration update message by a home subscriber server. The unique identifier comprises an IMEI.

In an aspect of the disclosure, the network entity comprises a home subscriber server, a home location register, or one or more of a Node B, a radio network controller, a mobile switching center, an evolved Node B and a mobility management entity.

In an aspect of the disclosure, the network entity comprises an apparatus configured to perform mobility management functions or radio resource management functions for the UE.

In an aspect of the disclosure, a method for maintaining connections related to multiple subscriptions includes the steps of maintaining a first wireless communications link corresponding to a first subscription and a second wireless communications link corresponding to a second subscription, refraining from performing a first radio resource procedure in relation to the first subscription after performing a similar radio resource procedure in relation to the second subscription, and synchronizing performance of a second radio resource procedure in relation to the first subscription with performance of the second radio resource procedure in relation to the second subscription. The first subscription and the second subscription may be associated with a common IMEI and different IMSIs and the contexts corresponding to the different IMSIs may be linked based on the IMEI.

In an aspect of the disclosure, the first radio resource procedure may comprise one or more of a UE capability exchange, a handover of the UE between base stations and a measurement reporting procedure. The measurement reporting procedure may relate to a drive tests procedure. The first radio resource procedure may comprise one or more of a tracking area update procedure, a location area update procedure and a routing area update procedure.

In an aspect of the disclosure, the performance of the second radio resource procedure is synchronized by monitoring pages corresponding to both the first subscription and the second subscription during a single paging occasion in a discontinuous reception cycle.

In an aspect of the disclosure, an apparatus for managing multiple contexts for a wireless device includes means for determining a link between a first context of a UE and a second context of the UE at a network entity, and means for combining procedures related to the first and the second contexts when the first context and the second context are linked.

In an aspect of the disclosure, an apparatus for wireless communication, includes a communications interface, and a processing circuit. The processing circuit may be configured to determine a link between a first context of a UE and a second context of the UE at a network entity, and combine procedures related to the first and the second contexts when the first context and the second context are linked.

In an aspect of the disclosure, a processor-readable storage medium includes one or more instructions which, when executed by at least one processing circuit, cause the at least one processing circuit to determine a link between a first context of a UE and a second context of the UE at a network entity, and combine procedures related to the first and the second contexts when the first context and the second context are linked.

In an aspect of the disclosure, a UE is configured to maintain connections related to multiple subscriptions. The UE may include a modem configured to communicate with a radio access network, and a processing system. The processing system may be configured to maintain a first wireless communications link corresponding to a first subscription and a second wireless communications link corresponding to a second subscription, refrain from performing a first radio resource procedure in relation to the first subscription after performing a similar radio resource procedure in relation to the second subscription, and synchronize performance of a second radio resource procedure in relation to the first subscription with performance of the second radio resource procedure in relation to the second subscription.

In an aspect of the disclosure, a UE configured to maintain connections related to multiple subscriptions, includes means for maintaining first and second wireless communications links corresponding to first and second subscriptions, respectively, and means for performing radio resource procedures. The means for performing radio resource procedures may be configured to refrain from performing a first radio resource procedure in relation to the first subscription after performing a similar radio resource procedure in relation to the second subscription. The means for performing radio resource procedures may be configured to synchronize performance of a second radio resource procedure in relation to the first subscription with performance of the second radio resource procedure in relation to the second subscription.

In an aspect of the disclosure, a processor-readable storage medium has one or more instructions which, when executed by at least one processing circuit, cause the at least one processing circuit to maintain a first wireless communications link corresponding to a first subscription and a second wireless communications link corresponding to a second subscription, refrain from performing a first radio resource procedure in relation to the first subscription after performing a similar radio resource procedure in relation to the second subscription, and synchronize performance of a second radio resource procedure in relation to the first subscription with performance of the second radio resource procedure in relation to the second subscription. The first subscription and the second subscription may be associated with a common IMEI and different IMSIs. The contexts corresponding to the different IMSIs may be linked based on the IMEI.

### BRIEF DESCRIPTION OF THE DRAWINGS

FIG. 1 is a simplified schematic diagram illustrating an example of a radio access network.

FIG. 2 is a simplified block diagram depicting certain elements of a networking environment based on UMTS.

FIG. 3 is a block diagram illustrating an access terminal that supports multiple SIMs and connects to a plurality of networks.

FIG. 4 is a block diagram illustrating a wireless network including radio access networks operated using different radio access technologies.

FIG. 5 illustrates a network that includes entities configured to maintain context for connected user equipment.

FIG. 6 is a flow diagram illustrating an example in which multiple contexts may be linked or combined in a consolidated context.

FIG. 7 is a message flow diagram illustrating an example of conventional handover of multiple contexts in a multiple subscription device.

FIG. 8 is a message flow diagram illustrating an example of handover of multiple contexts of a multiple subscription device when the contexts are linked according to certain aspects disclosed herein.

FIG. 9 is a flowchart illustrating a method of managing multiple contexts for a wireless device.

FIG. 10 is a schematic illustrating an apparatus configured to manage multiple contexts for a wireless device.

FIG. 11 is a flowchart illustrating a method of maintaining connections related to multiple subscriptions.

FIG. 12 is a schematic illustrating apparatus configured to maintain connections related to multiple subscriptions.

FIG. 13 is a flowchart illustrating a method for linking user equipment contexts associated with same physical device.

FIG. 14 is a schematic illustrating an apparatus configured to link user equipment contexts associated with same physical device.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

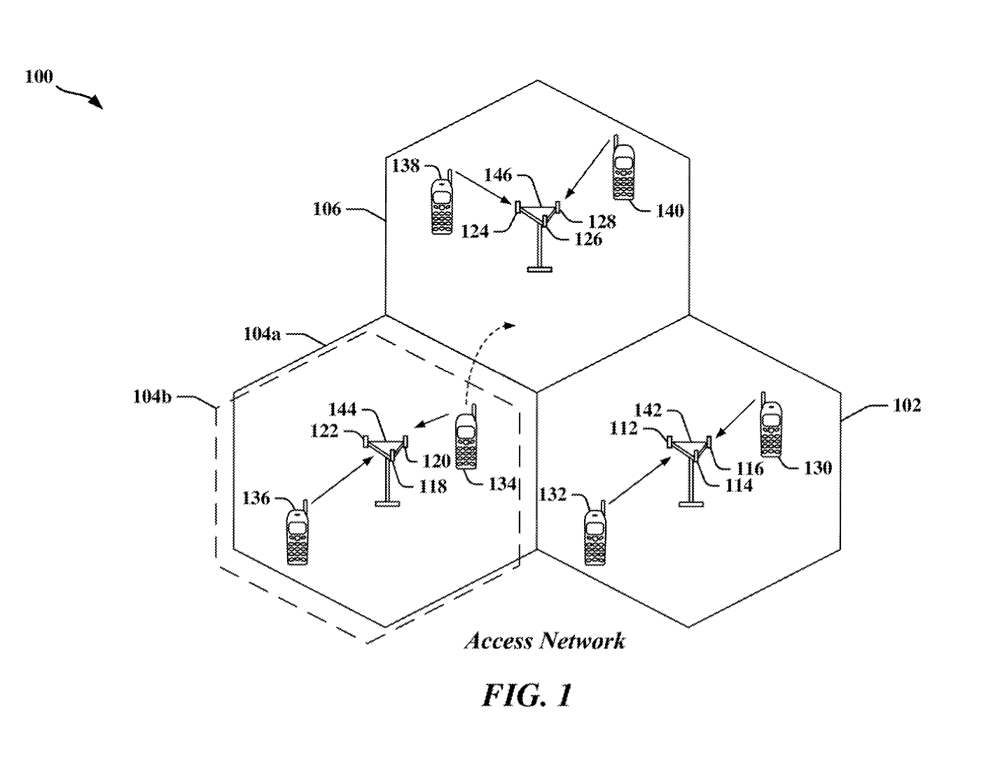

FIG. 1 is a simplified schematic diagram illustrating a radio access network (RAN) 100 in a UTRAN architecture. The RAN 100 includes multiple cellular regions (cells), including cells 102, 104, and 106, each of which may include one or more sectors. Cells may be defined geographically by coverage area, and/or may be defined in accordance with a frequency, scrambling code, etc. That is, the illustrated geographically-defined cells 102, 104, and 106 may each be further divided into a plurality of cells, through the use of different scrambling codes, for example. In one example, cell 104a may utilize a first scrambling code, and cell 104b, while in the same geographic region and served by the same Node B 144, may be distinguished by utilizing a second scrambling code.

In a cell that is divided into sectors, the multiple sectors within a cell can be formed by groups of antennas with each antenna responsible for communication with one or more access terminals in a portion of the cell. An access terminal may be referred to as a UE, including in relation to an access terminal configured to operate in networks complying or compatible with 3GPP standards. In the depicted example, antenna groups 112, 114, and 116 may each correspond to a different sector in cell 102. In cell 104, antenna groups 118, 120, and 122 may each correspond to a different sector. In cell 106, antenna groups 124, 126, and 128 may each correspond to a different sector.

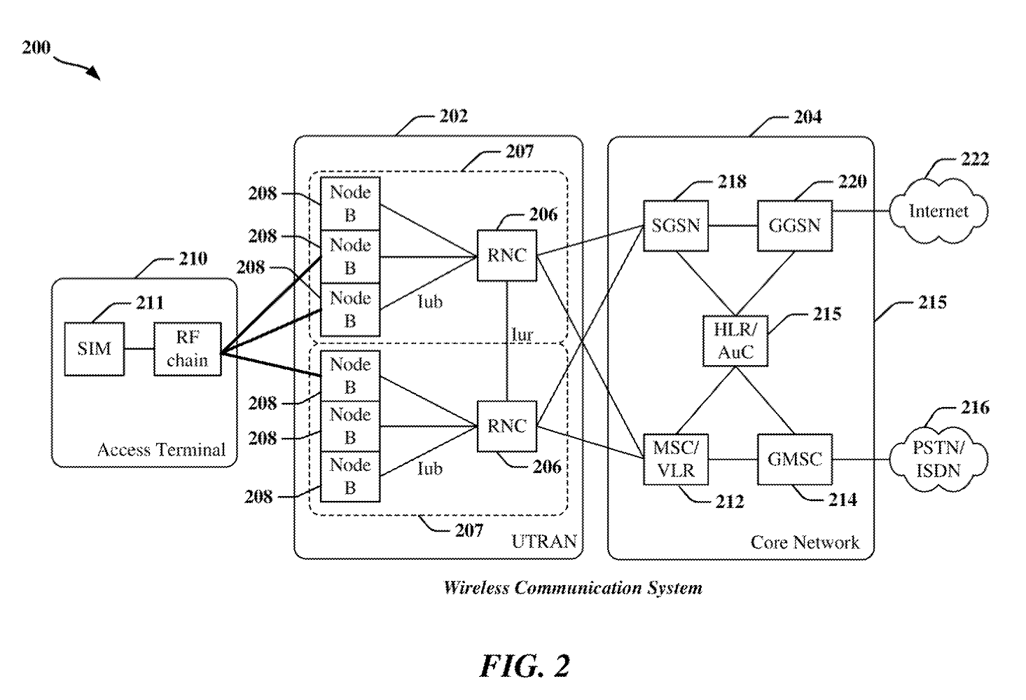

The cells 102, 104, and 106 may include several UEs that may be in communication with one or more sectors of each cell 102, 104, or 106. For example, UEs 130 and 132 may be in communication with Node B 142, UEs 134 and 136 may be in communication with Node B 144, and UEs 138 and 140 may be in communication with Node B 146. Here, each Node B 142, 144, and 146 may be configured to provide an access point to a core network 204 (see FIG. 2) for all the UEs 130, 132, 134, 136, 138, and 140 in the respective cells 102, 104, and 106.

During a call with a source cell, or at any other time, the UE 136 may monitor various parameters of the source cell as well as various parameters of neighboring cells. Further, depending on the quality of these parameters, the UE 136 may establish and/or maintain communication with one or more of the neighboring cells. During this time, the UE 136 may maintain an Active Set, which may include a list of cells to which the UE 136 is simultaneously connected (i.e., the UTRAN cells that are currently assigning a downlink dedicated physical channel DPCH or fractional downlink dedicated physical channel F-DPCH to the UE 136 may constitute the Active Set).

FIG. 2 is a schematic representation of a UMTS-based system 200 according to certain aspects of the present disclosure. A UMTS network includes three interacting domains: a core network 204, a RAN, and an access terminal 210. The RAN may comprise the UTRAN 202. In the depicted example, the UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. The UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. Such radio transceiver may be referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In the UMTS-based system 200, the UE 210 may further include one or more universal SIM (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). The illustrated core network 204 supports packet-switched data services such as General Packet Radio Service (GPRS), which may be accessed through a Serving GPRS Support Node (SGSN) and/or a Gateway GPRS Support Node (GGSN). GPRS is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UE 210 through the SGSN 218, which performs primarily the same functions in the packet-based domain as the MSC 212 performs in the circuit-switched domain. Some network elements may be shared by both of the circuit-switched and packet-switched domains.

In the illustrated example, the core network 204 supports circuit-switched services with the MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR 215 is also associated with an authentication center (AuC) that contains subscriber-specific authentication data. When a call is received for a particular UE 210, the GMSC 214 queries the HLR 215 to determine the location of the UE 210 and forwards the call to the particular MSC 212 serving that location.

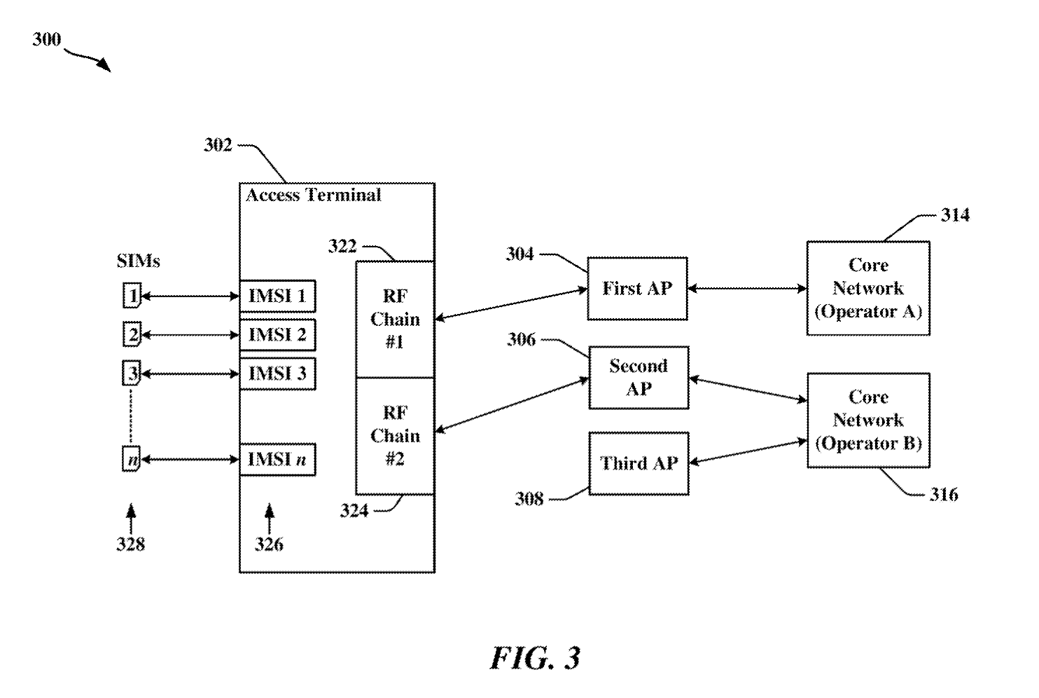

FIG. 3 is a diagram illustrating an access terminal 302 adapted to operate concurrently in multiple networks. The access terminal 302 may receive services provided by core networks 314 and 316. The access terminal 302 may communicate with a first access point 304 to obtain services from a first network 314. The access terminal 302 may communicate with a second access point 306 to obtain services from a second network 316. The access terminal 302 may obtain services from a single network 314 or 316 through two or more access points 304, 306 and/or 308. For example, the access terminal 302 may communicate with the second access point 306 and the third access point 308 to obtain services from the second network 316. Each network 314 and 316 may provide voice and/or data services through one or more RANs operated by the same or different network operators.

The access terminal 302 may be adapted or configured to support two or more SIMs 328 that can be used to identify and authenticate subscribed users of the different services offered by network operators. In one example, each SIM 328 may store an IMSI 326 and related keys that can uniquely identify and authenticate a user of the access terminal 302 and subscribed services available to the user through the networks 314 and/or 316. Each SIM 328 may be associated with a telephone number or other network identifier different from telephone numbers or other identifiers associated with the other SIMs 328. In one example, an access terminal 302 comprises a mobile telephone device equipped with two or more SIM cards 328 that enable the establishment of calls on two or more different voice and/or data networks, and to maintain two or more active calls concurrently. The use of multiple SIM cards 328 may permit a user of the access terminal 302 to access and use features of different subscriptions to reduce costs, obtain superior service, etc.

The access terminal 302 may support a variety of operational modes when multiple SIMs 328 are installed in the access terminal 302. For example, in dual SIM stand-by (DSS) mode, the access terminal 302 may initially be in standby mode for two different subscriptions. After establishing a call through one network 314 or 316, the access terminal 302 may cause the connection between the access terminal 302 and the other networks 316 or 314 to enter an inactive state.

In dual SIM dual active (DSDA) mode, the access terminal 302 may be concurrently connected to two different subscribed networks 314 and 316. A DSDA-enabled access terminal 302 may be capable of switching between two active calls and/or connecting two active calls at the access terminal 302. In DSDA mode, the access terminal 302 may establish a first active call on a first subscribed network 314, while remaining idle on a second subscribed network 316. While a call is active on a first subscribed network 314 or 316, a DSDA-enabled access terminal 302 may receive a second call through a second subscribed network 316 or 314. If calls are active on the first and second subscribed networks 314 and 316, a user may switch between the two calls as desired, and/or may connect the two calls at the access terminal 302. When more than two SIMs 328 are installed in the access terminal 302, other modes of operation may be defined, including triple SIM dual active (TSDA) mode, quad SIM dual active (QSDA) mode, for example.

A DSDA-enabled access terminal 302 may have a plurality of radio frequency (RF) chains 322 and 324. Each RF chain 322 and 324 may be operated and used for establishing and maintaining an active connection with an access point 304, 306, or 308. The plurality of RF chains 322, 324 may be embodied in one or more RF modems. An RF modem may comprise one or more RF chains 322, 324, each having at least one power amplifier (PA). In the example depicted in FIG. 3, the access terminal 302 may employ two RF chains 322, 324 to support concurrent connections to different access points 304 and 306 corresponding to networks 314 and 316, respectively. An RF modem may additionally comprise one or more processors, non-transitory storage and logic configured to process, transmit and receive signals, and to encode and decode data transmitted and received by the access terminal 302.

In triple SIM dual active (TSDA) mode, the access terminal 302 may support three subscriptions but can be connected to only two different ones of access points 304, 306, 308 concurrently. Typically, TDSA mode is adopted when an access terminal 302 is provided with only two RF chains 322 and 324 in order to optimize power consumption of the access terminal 302. In quad SIM dual active (QSDA) mode, the access terminal 302 may support four subscriptions but can be concurrently connected to only two different ones of access points 304, 306, 308. A QDSA-enabled access terminal 302 may be provided with only two RF chains 322 and 324 in order to optimize power consumption of the access terminal 302.

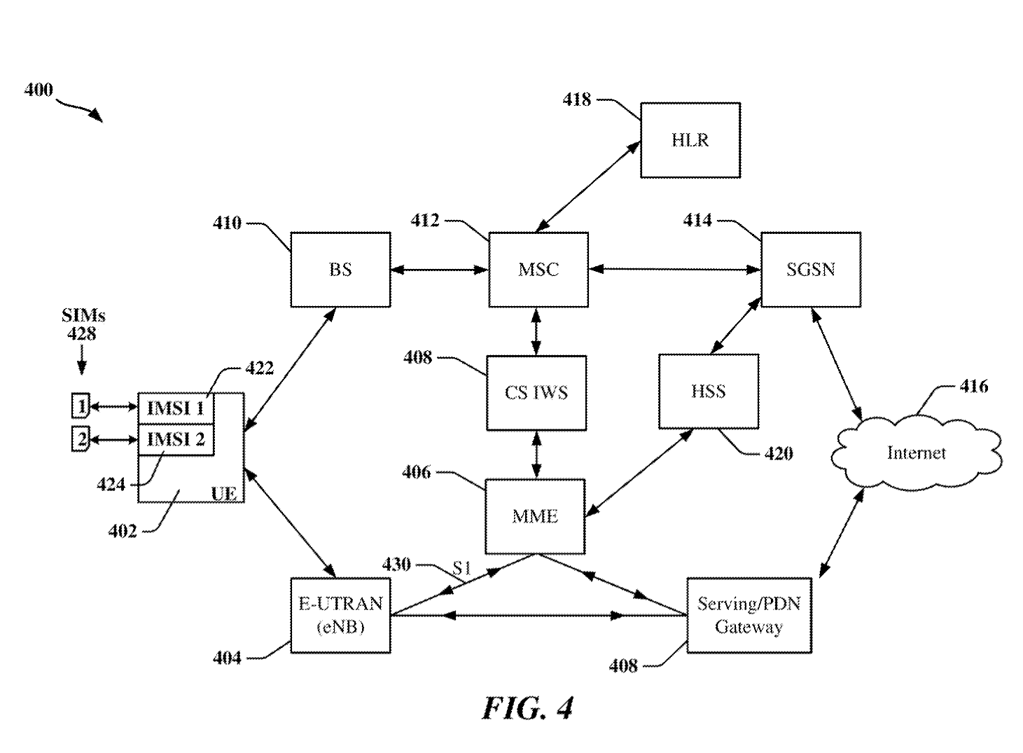

FIG. 4 is a block diagram 400 illustrating a simplified wireless internetworking environment. An access terminal 402 may be associated with one or more access points 404, 410 that may be operated by the same or different network operators and that may operate using the same or different network technology. The access point 404 and/or 410 may comprise, or be referred to, as a base station, a base transceiver station, a radio access point, an access station, a radio transceiver, a basic service set, an extended service set, a Node B, an evolved Node B (eNB), or some other suitable terminology. Each access point 404, 410 may provide a radio interface in a RAN that provides access to core network services provided by one or more network operators. RANs may be implemented using any suitable radio access technology (RAT) and telecommunication standards employing a variety of modulation and multiple access techniques. By way of example, RANs associated with access points 404, 410 may comprise one or more networks based on UTRAN, GSM, Long Term Evolution (LTE) which includes a set of enhancements to UMTS, Evolved UTRA (E-UTRA) network, IEEE 802.11 (Wi-Fi), IEEE 802.16 (WiMAX), IEEE 802.20, and/or Flash-OFDM employing OFDMA. RANs may also comprise one or more Evolution—Data Optimized (EV-DO) or Ultra Mobile Broadband (UMB) networks.

In the depicted example, the access terminal 402 may be associated with a PS network, such as LTE, through an eNB 404 and with a CS network for data and voice calls through the base station 410. Access terminal 402 may be registered with an E-UTRAN (through the eNB 404) and a packet data network (PDN) gateway 410 may provide connectivity between the access terminal 402 and one or more external packet data networks 416. The access terminal 402 may be registered with a 1xRTT CS network (which may be referred to as a 1x network) through base station 410 in order to obtain voice and data services through a CDMA-2000 network. GPRS permits 2G, 3G and W-CDMA mobile networks to transmit Internet Protocol (IP) packets to external networks such as the Internet 416 using a gateway function which may comprise a SGSN 414, which provides certain interworking services enabling communication between the GPRS system and an external packet switched network 416. Certain aspects of the invention are equally applicable to other combinations of PS and CS networks, including GSM for example.

In the example depicted in FIG. 4, the MME 406 serves as a control node for LTE traffic related to access terminal 402. The MME 406 typically processes signaling between the access terminal 402 and a core network, providing bearer and connection management services. In some embodiments, an interworking server (IWS) 408 may perform a single radio voice call continuity interworking solution function between UTRAN and E-UTRAN access networks. Accordingly, backhaul communications may be available between LTE and lx networks. The mobile switching center (MSC) 412 may control network switching elements used in the provision of 1xRTT voice services through base station 410.

The access terminal 402 may be deployed in a location where multiple accessible cells or RANs are available and the access terminal 402 may use different frequencies and/or different RATs to access a core network that provides mobility management, session management, transport for IP packet services, and other services. RATs may be based on UMTS, TD-SCDMA, GSM, CDMA2000 and/or WiMAX, for example.

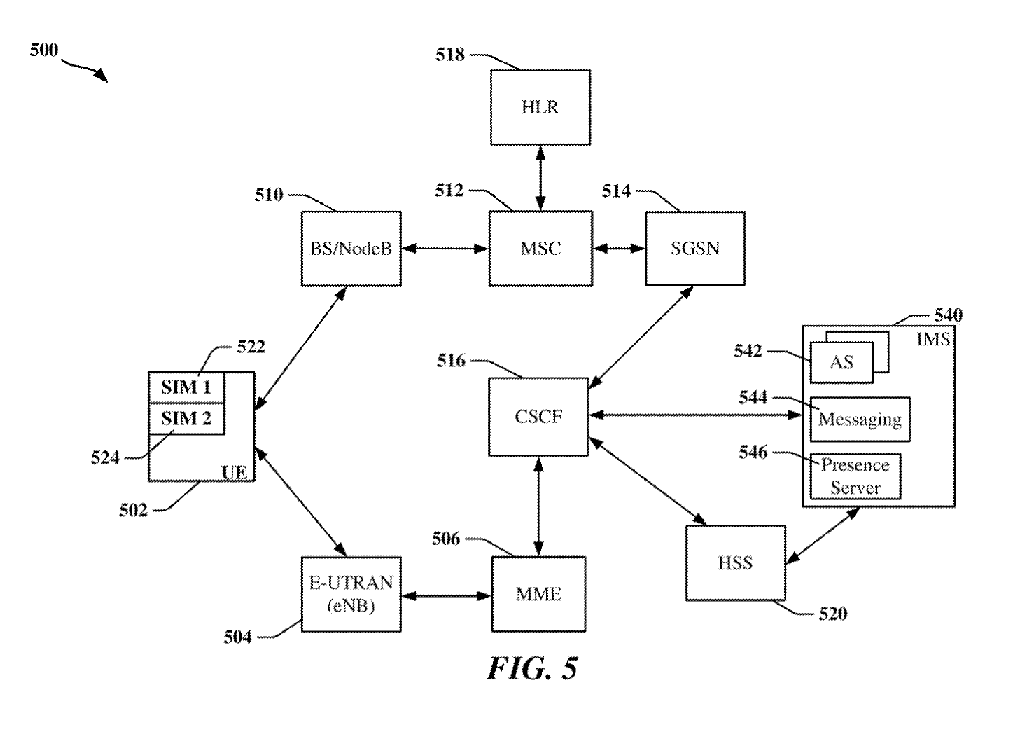

FIG. 5 is a block diagram 500 illustrating a network in which various entities may be configured to maintain subscription information related to user equipment 502. A core network entity may provide a centralized subscription manager comprising a database function that maintains subscription information, including subscriber profiles and information identifying subscriber location and IP connection information. The core network may distribute and/or delegate subscription management to one or more subscription management functions deployed across one or more network entities. A subscription manager may be associated with a database function that may be configured or adapted to implement, manage and/or control certain authentication and authorization of users in a wireless network. For example, a subscription manager and/or its associated subscription database function may be provided on one or more of a home subscriber server (HSS) 520 and a home location register (HLR) 518. The location and operation of the subscription manager and its associated subscription database function may be determined or selected based on the type of RAT used in the network and preferences of a network operator. The master user database may interact with subscriber information databases maintained by other network entities and elements of an IP multimedia core network subsystem (IMS) 540.

Multiple UE contexts may reside in the same database in the HSS 518 and/or the HLR 520. If these multiple UE contexts are not linked, duplicative radio resource management and mobility procedures may be performed in relation to the UE 502 by or on behalf of the respective network elements 504, 506, 510, 512, 514 and/or 520. According to certain aspects disclosed herein, the HLR 518 and/or HSS 520 may be configured to propagate UE contexts (or subsets thereof), which correspond to two or more simultaneously active SIM cards 522 and 524 in the UE 502, into network entities such as eNB 502, MME 506, Base Station 510, MSC 512, SGSN 514. The network entities may include entities that handle certain aspects of calls established by or on behalf of access terminals 502 using core network PS and CS services.

According to certain aspects disclosed herein, the HLR 518 and/or HSS 520 may be configured to propagate UE contexts (or subsets thereof) between entities of a core network, an IMS 540, and entities that provide interfaces between core networks and an IMS 540. For example, an entity that performs a call session control function (CSCF) 516 may comprise a session initiation protocol (SIP) server that handles session control functions for SIP terminals and exchanges user profiles with HSS 520. The HSS 520 and/or the HLR 518 may be configured to distribute context information to one or more application servers 542, 544 and 546 of the IMS 540. In one example, a presence server 546 may maintain information correlating user identities with subscription information. In another example, an instant messaging server 544 may support messaging services for subscribed users. Other application servers (AS) 542 may maintain or access subscription information for network users.

The HSS 520, which may also be referred to as a user profile server function (UPSF), is a network entity comprising a master user database that may support the IMS 504 and core network entities that establish, maintain, terminate and otherwise handle calls on behalf of UE 502. The HSS 520 may maintain subscriber profiles and other subscription-related information, and the HSS 520 may authenticate and authorize network access by the user. The HSS 520 may also maintain and deliver information related to the location of the UE 502, and information related to connections and services provided to a subscriber associated with the UE 502. The HLR 518 is a central database that maintains information related to a subscriber of the UE 502 who is authorized to use a GSM/GPRS core network. A plurality of HLRs 518 may be provided in a public land mobile network (PLMN). The HLR 518 may perform functions similar to those performed by the HSS 520.

A database record may be maintained by a network entity 520, 506, 518, 512, 510, 504 and/or 514 for each active user known to the network entity. The user may be identified through one or more SIMs 522, 524 installed in UE 502. The database record may comprise one or more UE Contexts corresponding to the UE 502. Each UE Context may define certain operational parameters associated with the UE 502, conditions reported by the UE 502, characteristics of the radio and/or IP bearer service and network internal routing information. A UE Context may be linked or tied to a subscription of the UE 502 identified by one of the SIMs 522 and 524. In one example, a UE Context may be referenced using an IMSI, which may be stored on a SIM 522 or 524.

Conventional networks may maintain overlapping UE Contexts for a single multi-SIM UE 502 and information regarding the UE 502 is frequently duplicated in the overlapping UE Contexts. In one example, a first UE Context corresponding to a first SIM 522 and a second UE Context corresponding to a second SIM 524 may be maintained by the network. The two UE Contexts may include certain identical or nearly identical copies of the same information, including information related to radio conditions, battery level, current location and radio access capabilities of the UE 502, for example. In some networks, radio resource management procedures, mobility and call/session management procedures are performed on a “per-UE Context” basis, founded on a conventional understanding of standards that contemplate that a UE 502 has only one attached SIM 522 or 524 at any time. Accordingly, duplicative radio resource management, mobility and call/session management procedures may be performed in relation to a UE 502 that supports multiple SIMs 522 and/or 524.

According to certain aspects disclosed herein, a consolidated context may be maintained for a multi-SIM UE 502. The consolidated context may associate multiple subscription-based UE Contexts with the UE 502. The subscription-based UE Contexts may be obtained from one or more network entities that maintain subscription information for different core networks, different RANs and/or different RATs. In one described example, UE Contexts for UE 502 may be maintained on an HLR 518/HSS HSS 520, where both UE Contexts may include duplicate records describing radio conditions, battery level, current location and radio access capabilities of the UE 502. These duplicate records may be updated from time to time and updates may involve performing certain procedures to obtain network and other measurements.

According to certain aspects disclosed herein, network entities may link, combine and/or synchronize multiple UE Contexts associated with a single UE 502 in order to obtain a consolidated context for the UE 502. This consolidated context may be employed as a single reference point for the context of a UE 502. In one example, the consolidated context may comprise a UE Context that is modified to include links to one or more other UE Contexts corresponding to the SIMs 522, 524. In another example, the consolidated context may be a UE Context that is modified to include the contents of multiple subscription-based UE Contexts corresponding to two or more SIMs 522, 524. A network entity may create a consolidated context by associating multiple subscriptions with an identifier that uniquely identifies the UE 502. The unique identifier may comprise one or more of an IMEI, a serial number of the UE 502, or other such identifier of the UE 502 or information identifying a user of the UE 502.

The use of a consolidated context can enable the sharing of information and the updating of information between the subscriptions, and can reduce or avoid duplicate performances of procedures by the UE 502. For example, duplicate measurement procedures by the UE 502 may be avoided when a UE 502 is connected to one or more base stations 510 and/or eNBs 504. The UE 502 may measure radio conditions once, and the measurements can be provided to any connected base station 510 or eNB 504.

According to certain aspects disclosed herein, the performance of certain procedures related to UE 502 can be coordinated, synchronized and/or limited when a plurality of UE Contexts are linked or consolidated for the same UE 502. Such procedures may include UE capability exchange procedures, handover procedures, DRX procedures and minimization of drive test (MDT) procedures. In one example, a single DRX paging occasion may be assigned for use with multiple subscriptions of the UE 502. DRX is a procedure that can reduce power consumption when one or more subscriptions of the UE 502 are in an idle mode. DRX enables the UE 502 to power down an RF chain 322, 324 (see FIG. 3) that is associated with an idle network connection for significant portions of a paging interval. The UE 502 powers up the RF chain only during paging occasions when UE 502 needs to monitor a paging channel for a page corresponding to its subscription. When DRX is coordinated for multiple subscriptions, the UE 502 can monitor a paging channel for pages corresponding to more than one subscription in one paging occasion per DRX cycle. In another example, MDT may be employed in LTE and UMTS RATs to exploit the measurement capabilities and geographical spread of commercially deployed UEs 130, 132, 134, 136, 138 and 140 (see FIG. 1) to collect radio measurements. When UE Contexts are consolidated, the UE 502 may refrain from acquiring more than one set of MDT measurements, regardless of the number of active subscriptions supported by the UE 502, when the same measurements would otherwise be acquired by the UE 502 for the different subscriptions.

According to certain aspects disclosed herein, multiple UE Contexts associated with a UE 502 may be linked at one or more network entities. The network entities may identify a UE Context associated with the UE 502 based on an IMSI corresponding to a SIM 522, 524 installed in the UE 502. When the UE 502 has a plurality of installed SIMs 522, 524, each SIM 522, 524 is typically associated with a different IMSI and the network identities may create Device Contexts for the plurality of SIMs 522 and 524. These Device Contexts may be linked in a consolidated context, and IMSI-specific procedures may be distinguished from device-specific procedures such that duplicate procedures may be suppressed.

According to certain aspects disclosed herein, session and/or mobility management entities including MME 506, MSC 512, SGSN 514, HLR 518 and/or HSS 520 may link UE Contexts tied to the same UE 502 to obtain a single consolidated context for a multi-SIM UE 502. The UE 502 may be uniquely identified, cross-referenced and/or linked using a common IMEI, serial number, or other such unique identifier tied to the UE 502. Links between UE Contexts may be implemented using pointers that identify the existence and location of related UE Contexts. UE Contexts may be linked by sharing information between network entities, including MME 506, MSC 512, SGSN 514, HLR 518 and HSS 520.

According to certain aspects disclosed herein, signaling protocols between network entities may be extended and/or enhanced to include information related to linked IMSIs. For example, during Attach/Registration_Update procedures, Authentication_Information_Response and/or Update_Location_Ack messages related to UE 502 may include information identifying and/or describing one or more other SIMs 522, 524 linked to the IMEI of the UE 502. In one example, the messages may be transmitted from HSS 520 to MME 506. A data structure may be employed to link multiple contexts associated with a single UE 502. The data structure may comprise class inheritance etc.

According to certain aspects disclosed herein, core network procedures may be optimized by linking UE Contexts in the core network. In an example where UE 502 has established a connection on behalf of a first SIM 522, paging may be optimized for a second SIM 524 by directing pages for the second SIM 524 to a specific cell and/or access point through which the connection for the first SIM 522 is established. In another example, a DRX cycle may be established in which the UE 502 receives pages at the same time for two or more connections corresponding to multiple SIMs 522, 524 supported by the UE 502. In another example, the existence of a preexisting MDT session for a first SIM 522 may preclude the need to initiate an MDT session for one or more other SIMs 524 associated with the same UE 502, because the other MDT sessions can be expected to produce near identical MDT measurements and logs as produced by the preexisting MDT session.

The processing overhead and power consumption associated with mobility management procedures may be reduced by sharing UE Contexts for multiple subscriptions. Mobility management procedures are used to track locations of UE 502 and procedures performed for different subscriptions related to the UE 502. Location area update (LAU), routing area update (RAU) and tracking area update (TAU) procedures may be initiated by the UE 502 when it detects a new tracking area, location area or routing area. The LAU procedure is typically used by a UE 502 to inform the network when the UE 502 moves from one location area to the next. In one example, a UE 502 may determine that a current location area code differs from a previously reported location area code, and the UE 502 may initiate a LAU procedure by sending the network a location update request that includes the previous and current location area codes with a Temporary Mobile Subscriber Identity (TMSI) issued in the current area. The RAU procedure is used in packet-switched networks in a manner that is equivalent to the use of the TAU. A routing area may be defined as a subdivision of a location area and may be used when UE 502 is connected in a GPRS network. The TAU procedure is used in LTE networks and corresponds to the LAU and RAU procedures used in UMTS networks. The UE 502 may refrain from initiating more than one of the LAU, RAU and TAU procedures, regardless of the number of active subscriptions supported by the UE 502, when the same procedure would otherwise need to be performed by the UE 502 for the different subscriptions. In one example, the initiation by the UE 502 of a LAU/RAU/TAU procedure for a first SIM 522 may cause the network entity responsible for mobility management procedures to update the location associated with one or more other SIMs 524 associated with the same UE 502, because the one or more other SIMs 524 are known by virtue of linked UE contexts to physically reside within the same UE 502.

According to certain aspects disclosed herein, radio access capabilities of a UE 502 can be reported once for all subscriptions of the UE 502. Radio access capabilities may be used to provision services for the UE 502 in a RAN. In a UMTS network, a RNC 206 is a governing entity in a UTRAN 202 that controls a plurality of Node Bs 208 (see FIG. 2) and performs radio resource management functions, including certain mobility management functions. In the UMTS network, UE Contexts may be linked by the RNC 206 of the UTRAN 202 or by an MSC 212 of the core network 204.

Multiple contexts associated with a single UE 502 may be linked in other control entities of a RAN, including in an eNode Bs 504 or an MME 506 in an LTE network. A consolidated device context for UE 502 may link UE contexts that correspond to the same IMEI. Certain types of information may be copied between a plurality of Device Contexts corresponding to the same IMEI and network entities may maintain an index or other data structure linking local Device Context to other Device Contexts, IMSIs, and networks associated with the same IMEI.

Information may be exchanged using internetworking messages and existing message types to transfer information between network entities. In the example of an LTE RAN, S1 signaling between eNB 504 and MME 506 may be extended to include information related to linked SIMs 522, 524. In one example, a message sent from MME 506 to eNB 504 requesting a setup of a new UE context associated with one or more SIMs 522, 524 associated with the UE 502, such as an initial UE_Context_Setup_Request message, may include information identifying and/or characterizing one or more other SIMs 522, 524 linked to the IMEI corresponding to the UE 502.

Certain radio resource management (RRM) procedures in a RAN may be optimized by linking different contexts associated with UE 502. In one example, scheduling may be coordinated for two or more subscriptions corresponding to SIMs 522, 524. Coordinated scheduling for UE 502 may involve consideration of power constraints as applied to multiple connections, battery condition, carrier assignments, etc. Resource grants and carrier assignments may be configured to allow each connection to transmit when the other connections are not transmitting such that each connection can transmit data with the full power in the power pool available to the UE 502. In another example, a common paging occasion may be assigned for all SIMs 522, 524 associated with the UE 502. UE capability reporting may be provided by one of the IMSIs 522 or 524. One set of measurements may be configured for each UE 502, and handovers may be optimized.

According to certain aspects disclosed herein, the UE 502 may be made aware that UE context is linked in the core network and/or in the RAN. In some embodiments, links may be established between protocol stacks at the RRC and Non-Access Stratum (NAS) layers. The RRC protocol handles the control plane signaling by which the RAN controls the behavior of the UE 502. RRC signaling encompasses various functional areas including system information related to broadcasting, connection control including certain handovers between cells, network-controlled inter-RAT mobility and measurement configuration. NAS comprises protocols which operate between the UE 502 and a core network, and NAS typically involves protocols which are not specific to a particular RAT. When the UE 502 is aware that contexts are linked to the extent necessary to support combined and/or optimized network procedures, the UE 502 may refrain from performing duplicative procedures such as radio measurements and capability reporting. The UE 502 may use the same paging occasions for all SIMs 522, 524. In some embodiments, UE 502 may perform a combined handover of connections corresponding to two or more SIMs 522, 524.

Linking UE Contexts tied to the same UE 502 may provide benefits that include prolonged battery life for UE 502, reduced over-the-air signaling and faster mobility procedures. The level of benefits accrued may depend upon the extent to which UE Contexts tied to the same device are linked and the degree of modification of procedures to take advantage of multi-SIM awareness in the core network.

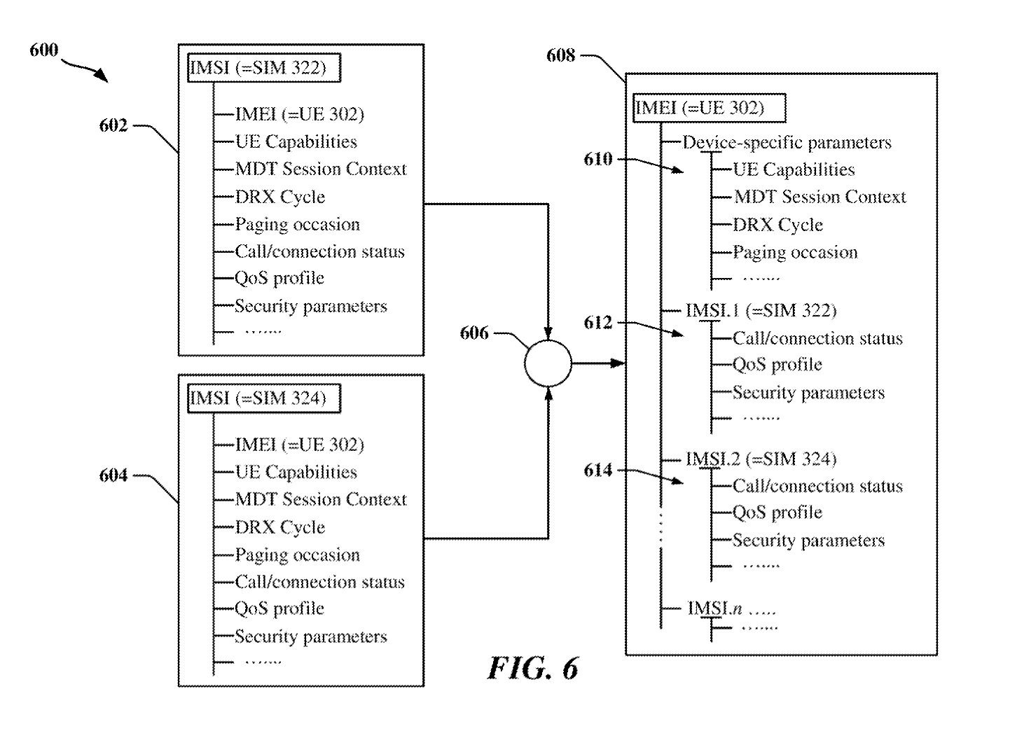

FIG. 6 is a simplified flow diagram 600 illustrating an example in which UE Contexts 602 and 604 may be linked or combined in a consolidated context 608. In the illustrated example, UE Contexts 602 and 604 relate to SIMs 522 and 524 installed in the multi-SIM UE 502 depicted in FIG. 5. In one example, the UE Contexts 602, 604 may be maintained in the form of a data structure populated for each SIM 522 and 524, where each SIM 522 and 524 is identified with an IMSI or other unique identifier corresponding to the subscription associated with the SIM 522 or 524. Each UE Context 602 and 604 may be populated with parameters that define the configuration and operational status of the subscription associated with the SIM 522 or 524 and/or the UE 502 in which the SIM 522 or 524 is installed. The parameters may include device-specific parameters including an IMEI or other unique identifier of the UE 502, UE capabilities, MDT session context, DRX cycle, defined paging occasions, etc. The parameters may also include IMSI-specific parameters including the IMSI, call/connection status, QoS profile, security parameters, etc. Certain device-specific context parameters may be duplicated between UE Contexts 602 and 604.

According to certain aspects disclosed herein, a network entity 606 may link and/or combine parameters from UE contexts 602 and 604 into a consolidated device context 608. In one example, the device context 608 may include sets of parameters 610, 612 and 616 that include device-specific set 610 and IMSI-specific sets 612 and 614. The device-specific set 610 may define UE capabilities, MDT session context, DRX context, paging occasion, etc. and other elements common to all UE Contexts 602 and 604. In one example, the device-specific set 610 may implicitly include the IMEI that is common to all Device Contexts 602 and 604 combined or linked in the device context 608. In another example, the IMEI may be included in a field in the device-specific set 610 and/or in the IMSI-specific sets 612 and 614. IMSI-specific sets may include parameters and variables that are defined independently for each subscription associated with a SIM 522 or 524 installed in the UE 502. The IMSI-specific parameters may relate to call status, call configuration such as QoS parameters and security parameters defined for the subscription.

The network entity 606 may create a data structure 608 that maps the UE Contexts 602 and 604 and elements of the UE Contexts 602 and 604 onto a device context 608. In one example, the network entity 606 may initialize the device context 608 by copying parameters from the UE Contexts 602 and 604 into the device context 608. The network entity 606 may synchronize the parameters within the device context 608 with the contents of the UE context 602 and the UE Context 604. The device context 608 and/or the UE Contexts 602 and 604 may be synchronized by updating device-specific parameters. When corresponding fields of UE Context 602, UE Context 604 and/or the device context 608 have different values, conflicts may be resolved using timestamps to determine which context 602, 604 or 608 has the most recently obtained value. Thus, for example, a current network measurement obtained in relation to UE Context 602 may be copied to device context 608 and thence to UE context 604 when the network measurement in UE context 602 is more recently obtained than the corresponding values found in device context 608 and/or UE Context 604.

In some embodiments, conventional UE Contexts 602 and 604 may be adapted and/or expanded to obtain the device-context data structure 608 that includes a device-specific set of parameters 610 and IMSI-specific sets of parameters 612, 614 for each SIM 522 and 524 installed in the UE 502. Accordingly, a single modified context may be replicated throughout the network, with updates being propagated by a context manager, which may be incorporated in network entity 606. In some embodiments, UE Contexts 602 and 604 may be mapped and/or indexed using the IMEI of UE 502, whereby a network entity 606 may track all instances of UE Contexts 602 and 604 and may synchronize the device-specific content of the different UE Contexts 602 and 604. In one example, an IMEI may be used as a pointer to the storage locations where linked UE Contexts 602 and 604 are stored.

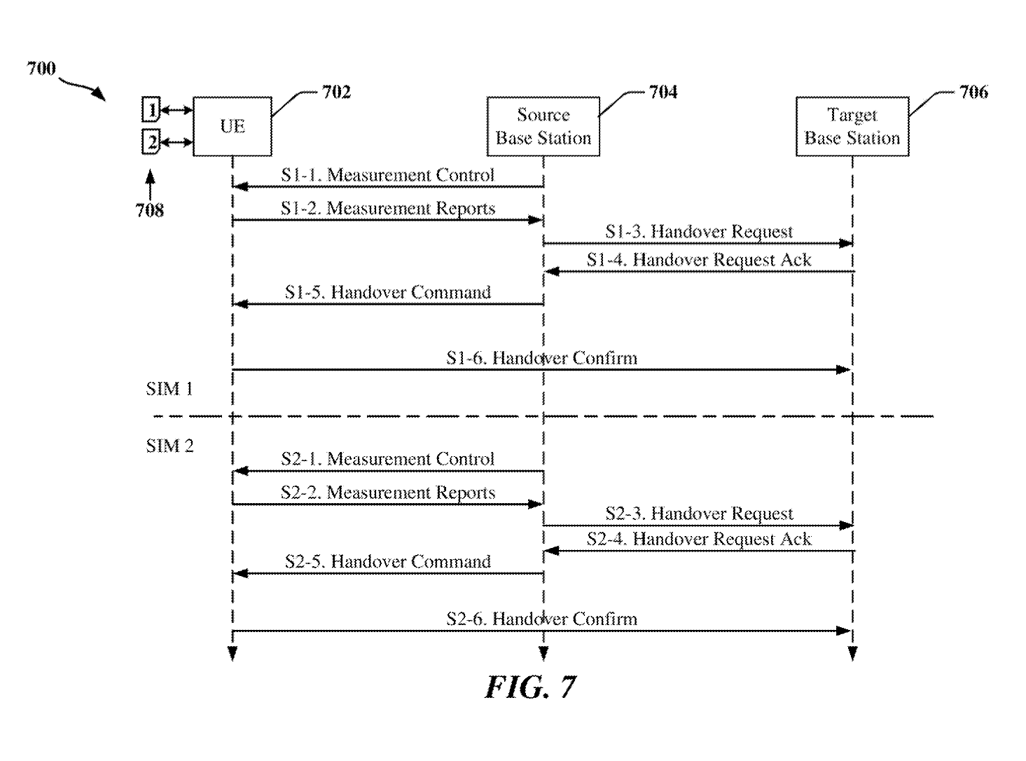

FIG. 7 is a simplified message flow diagram 700 illustrating an example of conventional handover of multiple contexts in a multiple subscription device, such as the UE 702. In the example, two or more SIMs 708 are installed in the UE 702, each SIM identifying a subscription of the UE 702. The UE 702 is initially associated and/or in communication with a source base station 704 for a first subscription of the UE 702, and the context for the first subscription is handed over to a target base station 706. As described herein, the UE 702 may receive a measurement control message S1-1 for the first subscription, which is associated with a first one of the SIMs 708. The measurement control message S1-1 may be accompanied by and/or be followed by an uplink allocation to permit the UE 702 to transmit measurement reports for the first subscription in an uplink message S1-2. The source base station 704 may determine that a handover should be initiated based on the content of the measurement reports. Accordingly, the source base station 704 may send a handover request S1-3 for the first subscription to the target base station 706, which may be identified based on the measurement reports for the first subscription. In the illustrated example, the target base station 706 sends a handover request acknowledgement message S1-4 to the source base station 704, which may then transmit a handover command S1-5 to the UE 702. The UE 702 then attempts to acquire the target base station 706 and one or more synchronization transmissions and/or messages S1-6 may be exchanged between the UE 702 and the target base station 706 on behalf of the first subscription. The handover of the first subscription is completed when the UE 702 sends a handover confirm message S1-7 to the target base station 706.

In a conventional system, the handover procedure is performed twice, and the two performances may occur in parallel or sequentially for the same UE 702. As illustrated in FIG. 7, the UE 702 is also initially associated and/or in communication with the source base station 704 for a context associated with a second subscription of the UE 702, and the context for the second subscription is handed over to a target base station 706. As described herein, the UE 702 may receive a measurement control message S2-1 for the second subscription, which is associated with a second one of the SIMs 708. The measurement control message S2-1 may be accompanied by and/or be followed by an uplink allocation to permit the UE 702 to transmit measurement reports for the second subscription in an uplink message S2-2. The source base station 704 may determine that a handover should be initiated based on the content of the measurement reports for the second subscription. In this example, the source base station 704 independently decides that a handover should occur for both subscriptions, based on their respective measurement reports S1-2 and S2-2, which typically include the same measurement information. The source base station 704 may send a handover request S2-3 for the second subscription to the target base station 706, which is identified based on the measurement reports for the second subscription. In the illustrated example, the target base station 706 sends a handover request acknowledgement message S2-4 to the source base station 704, which may then transmit a handover command S2-5 to the UE 702. The UE 702 then attempts to acquire the target base station 706 and one or more synchronization transmissions and/or messages S2-6 may be exchanged between the UE 702 and the target base station 706 on behalf of the second subscription. The handover of the second subscription is completed when the UE 702 sends a handover confirm message S2-7 to the target base station 706.

Each message in the message flow chart is associated with a single UE Context. Accordingly, the number of transmissions is at least doubled and the time required to execute a handover of both contexts may be doubled if the handovers for the two contexts are handled separately.

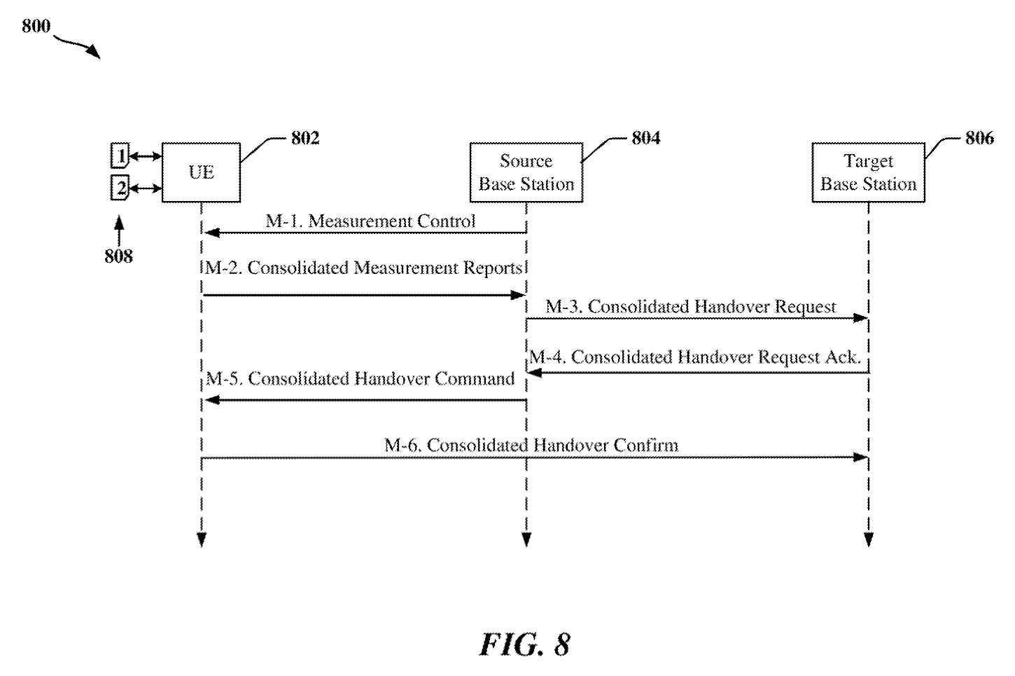

FIG. 8 is a simplified message flow diagram illustrating an example of handover of multiple contexts of a multiple subscription device when the contexts are linked according to certain aspects disclosed herein. In the example, the UE 802 is associated and/or in communication with a source base station 804 for two contexts associated with first and second subscriptions of the UE 802, and the context for both subscriptions is handed over to a target base station 806 in a consolidated process. The consolidation is achieved by identifying the contexts for both subscriptions in each message. As described herein, the UE 802 may receive a measurement control message M-1 to configure measurement reports to be sent from the UE 802 to the source base station 804. The measurement control message M-1 may be associated with the first or second subscription. The UE 802 may determine if measurement reports have been recently transmitted on behalf of the other subscription and may refrain from sending a duplicate measurement report. Alternatively, the measurement control message may be a consolidated message associated with both subscriptions. The UE 802 may respond to the measurement control message M-1 by transmitting measurement reports in an uplink message M-2. The measurement reports may be a consolidated message associated with both subscriptions. The source base station 804 may determine that a handover should be initiated based on the content of the measurement reports. In this example, the source base station 804 decides that a handover should occur for both subscriptions, based on a single consolidated measurement report M-2. The source base station 804 may send a handover request M-3 identifying the device context and/or an identification of the linked context information maintained by a network entity. In the illustrated example, the target base station 806 sends a handover request acknowledgement message M-4 to the source base station 804, which may include the device context. The source base station 804 may then transmit a single consolidated handover command M-5 to the UE 802. The UE 802 may attempt to acquire the target base station 806 for both UE contexts. The handover is completed when the UE 802 sends a single consolidated handover confirm message M-6 to the target base station 806.

Identification of the contexts for both subscriptions in a consolidated message can be achieved by including context-related ID, such as a mobile subscriber identifier (an IMSI, a TIMSI, a P-TIMSI) or a radio network identifier (RNTI, C-RNTI, U-RNTI), for each of the two contexts in the message. Alternatively, the identification of the context for both subscriptions in a message can be achieved by including a single user equipment-related ID associated with both contexts, such as the IMEI, in the message. Accordingly, signaling procedures such as the handover procedure and the associated messages may be simplified by performing a single procedure for all contexts linked to the same device.

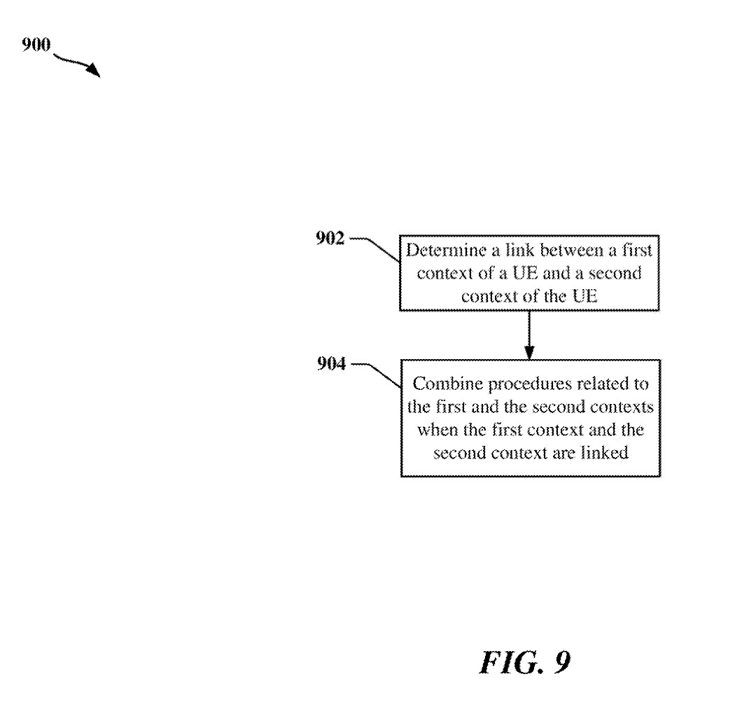

FIG. 9 is a flowchart illustrating a method of managing multiple contexts for a wireless device. Certain steps of the method may be performed by one or more network entities such as an HLR 518, an HSS 520, an MME 506, an MSC 512, an RNC 206, an SGSN 514, a CSCF 516 and/or an entity of an IMS 540, for example.

At step 902, the network entity may determine a link between a first context of a UE and a second context of the UE. The first context and the second context may be associated with a common IMEI of the UE and different IMSIs.

At step 904, the network entity may combine procedures related to the first and the second contexts when the first context and the second context are linked. The procedures related to the first and the second contexts may be combined by synchronizing procedures related to the different IMSIs.

According to certain aspects disclosed herein, procedures related to the first and the second UE contexts may be combined by performing a device-specific procedure in relation to the first context, and refraining from performing the device-specific procedure in relation to the second context. A result of the device-specific procedure may be propagated between the first and second contexts. The procedures may include at least one radio resource procedure. The at least one radio resource procedure may comprise a UE capability exchange. The at least one radio resource procedure may comprise a handover of the UE between base stations. The at least one radio resource procedure may comprise one or more of a TAU procedure, a LAU procedure, and a RAU procedure.

According to certain aspects disclosed herein, procedures related to the first and the second UE contexts may be combined by initiating a measurement reporting procedure at the UE. The measurement reporting procedure may be adapted to minimize a drive tests procedure.

According to certain aspects disclosed herein, procedures related to the first and the second UE contexts may be combined by causing the UE to monitor pages corresponding to both the first context and the second context during a single paging occasion in a DRX cycle.

According to certain aspects disclosed herein, the network entity may coordinate assignment of resources for the first context and the second context. The resources are assigned based on a power constraint of the UE.

According to certain aspects disclosed herein, the first context and the second context may be determined to be linked based on an information exchange between the network entity and another network entity, the information relating the first context and the second context to a unique identifier of the UE. The information exchanged between the network entity and the other network entity may include information relating the first context and the second context transmitted in an attach or registration update message by a home subscriber server. The unique identifier may comprise an IMEI. The network entity may comprise an apparatus configured to perform mobility management functions or radio resource management functions for the UE.

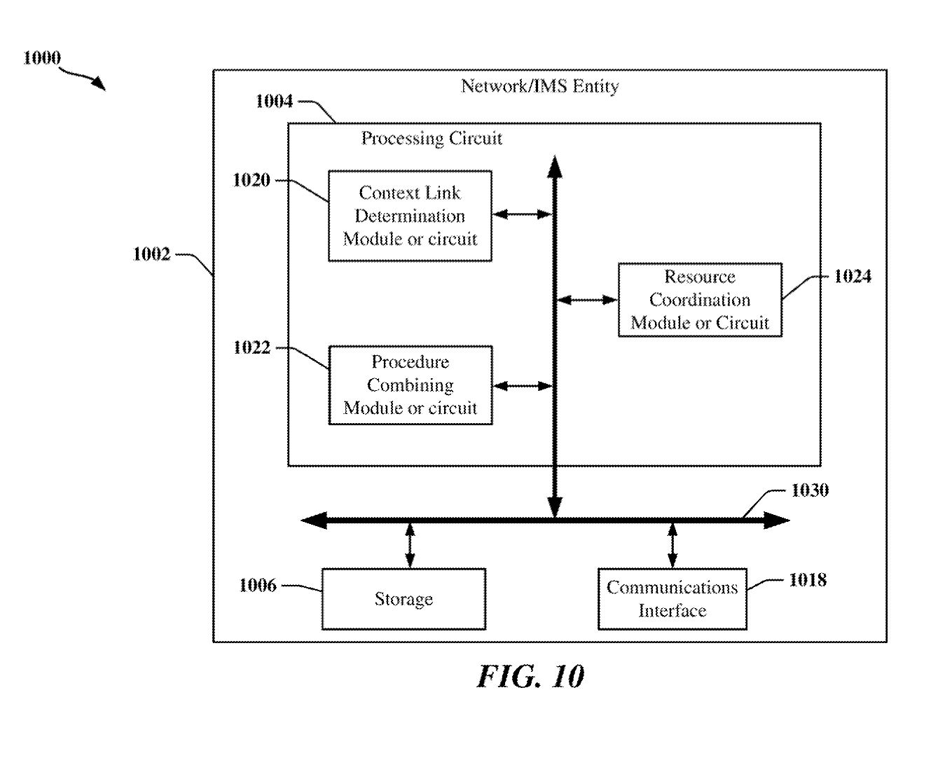

FIG. 10 is a diagram 1000 illustrating an example of a hardware implementation for an apparatus 1002 configured to manage multiple contexts for a wireless device. The apparatus 1002 may comprise a network and/or IMS entity that performs session management and/or mobility management functions in a network that supports one or more RANs and employs one or more RATs. The processing circuit 1004 may be implemented with a bus architecture, represented generally by the bus 1030. The bus 1030 may include any number of interconnecting buses and bridges depending on the application and attributes of the processing circuit 1004 and overall design constraints. The bus 1030 may link together various circuits including one or more processors and/or hardware modules, processing circuit 1004, and the computer-readable medium 1006. The bus 1030 may also link various other circuits such as timing sources, peripherals, voltage regulators, and power management circuits, which are well known in the art, and therefore, will not be described any further.

The processing circuit 1004 may be coupled to one or more communications interfaces 1018. The one or more communications interfaces 1018 may be used for communications between entities of a core network, within and between RANs and between core network entities and servers and other entities of an IMS. The one or more communications interfaces 1018 may be coupled by wired or wireless transmission media.

The processing circuit 1004 may include one or more processors responsible for general processing, including the execution of software stored on the computer-readable medium 1006. The software, when executed by the one or more processors, cause the processing circuit 1004 to perform the various functions described supra for any particular apparatus. The computer-readable medium 1006 may also be used for storing data that is manipulated by the processing circuit 1004 when executing software. The processing system further includes at least one of the modules 1020, 1022 and 1024. The modules 1020, 1022 and 1024 may be software modules running on the processing circuit 1004, resident/stored in the computer readable medium 1006, one or more hardware modules coupled to the processing circuit 1004, or some combination thereof.

In one configuration, the apparatus 1002 for wireless communication includes means 1020 for determining a link between a first context of a UE and a second context of the UE, means 1022 for combining procedures related to the first and the second contexts when the first context and the second context are linked, and means 1024 for coordinating assignment of resources for the first context and the second context.

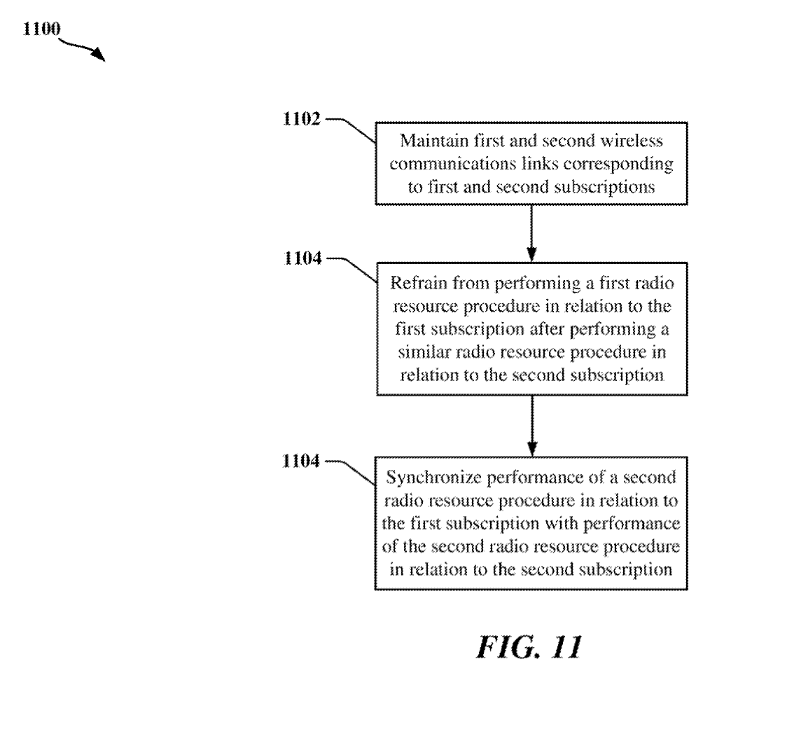

FIG. 11 is a flowchart illustrating a method of maintaining connections related to multiple subscriptions. Certain steps of the method may be performed by the UE 502, for example.

At step 1102, the UE 502 may maintain a first wireless communications link corresponding to a first subscription and a second wireless communications link corresponding to a second subscription. The first subscription and the second subscription may be associated with a common IMEI of the UE 502 and different IMSIs. The contexts corresponding to the different IMSIs may be linked in a context corresponding to the IMEI. The context corresponding to the IMEI may be maintained by a network or IMS entity.

At step 1104, the UE 502 may refrain from performing a first radio resource procedure in relation to the first subscription after performing a similar radio resource procedure in relation to the second subscription. The first radio resource procedure may include one or more of a UE capability exchange, a handover of the UE 502 between base stations and a measurement reporting procedure. The measurement reporting procedure may relate to a drive tests procedure. The first radio resource procedure may include one or more of a tracking area update procedure, a location area update procedure and a routing area update procedure.

At step 1106, the UE 502 may synchronize performance of a second radio resource procedure in relation to the first subscription with performance of the second radio resource procedure in relation to the second subscription. Performance of the second radio resource procedure may be synchronized by monitoring pages corresponding to both the first context and the second context during a single paging occasion in a discontinuous reception cycle.

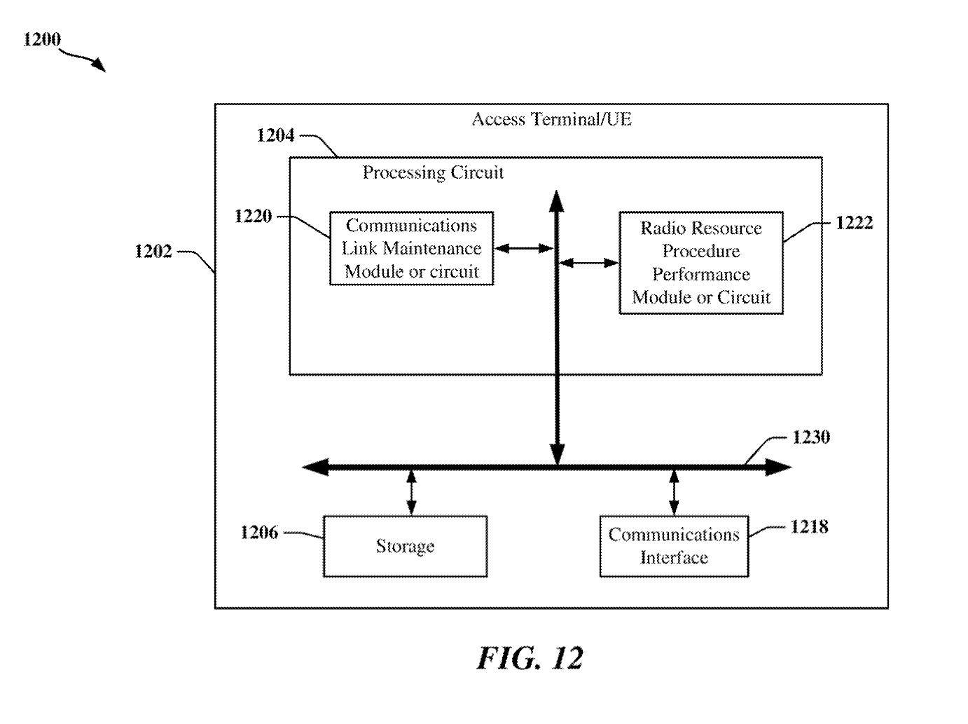

FIG. 12 is a diagram 1200 illustrating an example of a hardware implementation for an apparatus 1202 employing a processing circuit 1204 and configured to maintain connections related to multiple subscriptions. The apparatus 1202 may comprise a UE 502 that supports a plurality of wireless subscriptions. The processing circuit 1204 may be implemented with a bus architecture, represented generally by the bus 1230. The bus 1230 may include any number of interconnecting buses and bridges depending on the application and attributes of the processing circuit 1204 and overall design constraints. The bus 1230 may link together various circuits including one or more processors and/or hardware modules, processing circuit 1204, and the computer-readable medium 1206. The bus 1230 may also link various other circuits such as timing sources, peripherals, voltage regulators, and power management circuits, which are well known in the art, and therefore, will not be described any further.

The processing circuit 1204 may be coupled to one or more communications interfaces 1218. The one or more communications interfaces 1218 may be used for communications between entities of a core network, within and between RANs and between core network entities and servers and other entities of an IMS. The one or more communications interfaces 1218 may be coupled by wired or wireless transmission media.

The processing circuit 1204 may include one or more processors responsible for general processing, including the execution of software stored on the computer-readable medium 1206. The software, when executed by the one or more processors, cause the processing circuit 1204 to perform the various functions described supra for any particular apparatus. The computer-readable medium 1206 may also be used for storing data that is manipulated by the processing circuit 1204 when executing software. The processing system further includes at least the modules 1220 and 1222. The modules 1220 and 1222 may be software modules running on the processing circuit 1204, resident/stored in the computer readable medium 1206, one or more hardware modules coupled to the processing circuit 1204, or some combination thereof.

In one configuration, the apparatus 1202 for wireless communication includes means 1220 for maintaining first and second wireless communications links corresponding to first and second subscriptions, respectively, and means 1222 for performing radio resource procedures.

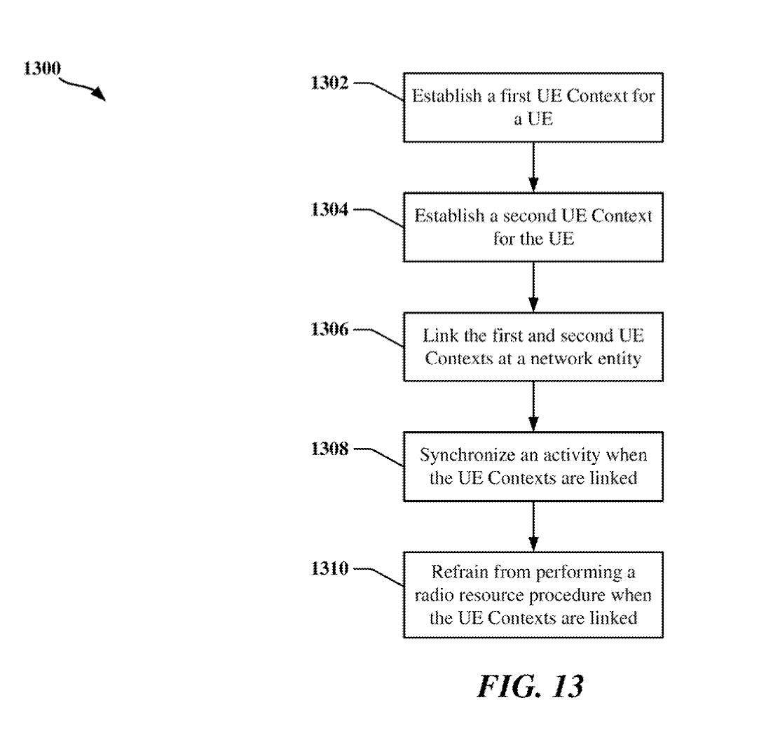

FIG. 13 is a flowchart illustrating a method for linking user equipment contexts associated with same physical device. Certain steps of the method may be performed by one or more network entities such as an HLR 1318, an HSS 1320, an MME 1306, an MSC 1312, an RLC, an SGSN 1314, for example.

At step 1302, a first context may be established for a UE based on a first IMSI provided by the UE.

At step 1304, a second context may be established for the UE based on a second IMSI provided by the UE.

At step 1306, the network entity may link the first context and the second context at the network entity. The first context and the second context may be linked by associating the first context and the second context with a common IMEI of the UE. The first context and the second context may be linked at the network entity by exchanging information with another network entity. The other network entity may maintain UE Context information related to the UE. The information may relate or bind the first context and the second context to the UE. The network entities may exchange information related to the first context and the second context in an attach or registration update message from a home subscriber server. The information relating the first context and the second context to the UE may comprise an IMEI of the UE.

At step 1308, an activity related to the UE may be synchronized when the first context and the second context are linked. The activity may be synchronized by causing the UE to monitor page indicators corresponding to both the first context and the second context during a single paging occasion in a DRX cycle. The activity may be synchronized by coordinating assignment of resources for the first context and the second context. The resources are assigned based on a power constraint of the UE.

At step 1310, the network entity may refrain from, or cause another entity to refrain from performing at least one radio resource procedure in relation to the UE when the first context and the second context are linked. The at least one radio resource procedure may include a UE capability exchange. The at least one radio resource procedure may include a handover of the UE between base stations. The at least one radio resource procedure may includes initiating a minimization of drive tests procedure at the UE. The at least one radio resource procedure may include one or more of a TAU procedure, a LAU procedure, and a RAU procedure.

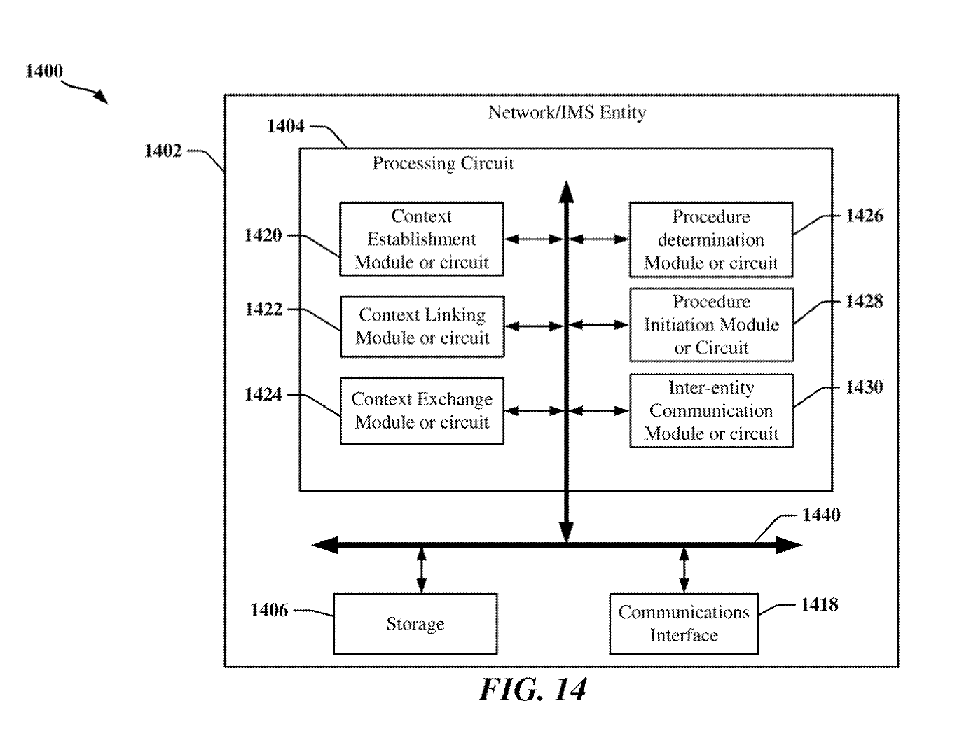

FIG. 14 is a diagram 1400 illustrating an example of a hardware implementation for an apparatus 1402 employing a processing circuit 1404 and configured to link user equipment contexts associated with same physical device. The apparatus 1402 may comprise a network entity that performs session management and/or mobility management functions in a network that supports one or more RANs and employs one or more RATs. The processing circuit 1404 may be implemented with a bus architecture, represented generally by the bus 1440. The bus 1440 may include any number of interconnecting buses and bridges depending on the application and attributes of the processing circuit 1404 and overall design constraints. The bus 1440 may link together various circuits including one or more processors and/or hardware modules, processing circuit 1404, and the computer-readable medium 1406. The bus 1440 may also link various other circuits such as timing sources, peripherals, voltage regulators, and power management circuits, which are well known in the art, and therefore, will not be described any further.

The processing circuit 1404 may be coupled to one or more communications interfaces 1418. The one or more communications interfaces 1418 may be used for communications between entities of a core network, within and between RANs and between core network entities and servers and other entities of an IMS. The one or more communications interfaces 1418 may be coupled by wired or wireless transmission media.

The processing circuit 1404 may include one or more processors responsible for general processing, including the execution of software stored on the computer-readable medium 1406. The software, when executed by the one or more processors, cause the processing circuit 1404 to perform the various functions described supra for any particular apparatus. The computer-readable medium 1406 may also be used for storing data that is manipulated by the processing circuit 1404 when executing software. The processing system further includes at least one of the modules 1420, 1422, 1424, 1426, 1428 and 1430. The modules 1420, 1422, 1424, 1426, 1428 and 1430 may be software modules running on the processing circuit 1404, resident/stored in the computer readable medium 1406, one or more hardware modules coupled to the processing circuit 1404, or some combination thereof. The processing circuit 1404 may be a component of a UE 302 (see FIG. 3).

In one configuration, the apparatus 1402 for wireless communication includes a module 1420 for establishing first and second contexts for a UE based on a first IMSI provided by the UE, a module 1422 for linking the first context and the second context at the network entity, and a module 1424 for exchanging UE contexts associated with a UE that supports multiple concurrently active subscriptions. The module 1424 for exchanging UE contexts may comprise a module for consolidating or otherwise combining multiple UE contexts into a single context for a multi-SIM or multi-subscription UE. The apparatus 1402 may comprise a module 1426 that determines a first set of procedures to be performed in relation to the UE that are UE-specific and a second set of procedures to be performed in relation to the UE that are IMSI-specific (i.e. related to subscriptions corresponding to fewer than all of the IMSIs associated with the UE). The apparatus 1402 may comprise a module 1428 for initiating procedures defined by the first and second sets of procedures. In one example, the module 1428 for initiating procedures may avoid duplicate procedures by causing each of the first set of procedures to be performed once for each occasion on which the procedure is to be performed while procedures identified in the second set may be performed for each IMSI or group of IMSIs that require the procedures. Accordingly, the module 1428 for initiating procedures may be configured to synchronize one or more activities related to the UE or refraining from having at least one radio resource procedure performed in relation to the UE when the first context and the second context are linked. The apparatus 1402 may comprise a module 1430 for managing communications between network entities, including communications between different RANs, RATs, core networks and IMS environments. For example, the module 1430 for managing communications may comprise an IWS 408 (see FIG. 4) and CSCF 516 (see FIG. 5).

The term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die.

One or more of the components, steps, features and/or functions illustrated in FIGS. 1-14 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5, 7, 8, 10, 12 and 14 may be configured to perform one or more of the methods, features, or steps described herein. The novel algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” or “machine readable storage medium” include, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits (e.g., processing circuit), elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A method of managing multiple contexts for a wireless device, comprising:
determining a link between a first context of a user equipment (UE) and a second context of the UE at a network entity; and
combining procedures related to the first and the second contexts when the first context and the second context are linked.

2. The method of claim 1, wherein the first context and the second context are associated with different international mobile subscriber identities (IMSIs), and wherein the link between the first context and the second context is determined when the first context and the second context are associated with a common international mobile equipment identity (IMEI) of the UE.

3. The method of claim 2, wherein combining procedures related to the first and the second contexts includes synchronizing procedures related to the different IMSIs.

4. The method of claim 2, wherein combining procedures related to the first and the second contexts includes:
performing a device-specific procedure in relation to the first context; and
refraining from performing the device-specific procedure in relation to the second context, wherein a result of the device-specific procedure is propagated between the first context and the second context.

5. The method of claim 2, wherein the procedures include at least one radio resource procedure.

6. The method of claim 5, wherein the at least one radio resource procedure comprises a UE capability exchange.

7. The method of claim 5, wherein the at least one radio resource procedure comprises a handover of the UE between base stations.

8. The method of claim 5, wherein the at least one radio resource procedure comprises one or more of a tracking area update procedure, a location area update procedure, and a routing area update procedure.

9. The method of claim 5, wherein combining procedures related to the first and the second contexts includes initiating a measurement reporting procedure at the UE.

10. The method of claim 9, wherein the measurement reporting procedure is adapted to minimize a drive tests procedure.

11. The method of claim 1, wherein combining procedures related to the first and the second contexts comprises causing the UE to monitor pages corresponding to both the first context and the second context during a single paging occasion in a discontinuous reception (DRX) cycle.

12. The method of claim 1, further comprising coordinating assignment of resources for the first context and the second context, wherein the resources are assigned based on a power constraint of the UE.

13. The method of claim 1, wherein the first context and the second context are determined to be linked based on an information exchange between the network entity and another network entity, the information relating the first context and the second context to a unique identifier of the UE.

14. The method of claim 13, wherein the information exchanged between the network entity and the another network entity includes information relating the first context and the second context transmitted in an attach or registration update message by a home subscriber server.

15. The method of claim 13, wherein the unique identifier comprises an IMEI.

16. The method of claim 1, wherein the network entity comprises a home subscriber server or a home location register.

17. The method of claim 1, wherein the network entity comprises one or more of a Node B, a radio network controller, a mobile switching center, an evolved Node B and a mobility management entity.

18. The method of claim 1, wherein the network entity comprises an apparatus configured to perform mobility management functions or radio resource management functions for the UE.

19. An apparatus for managing multiple contexts for a wireless device, comprising:
means for determining a link between a first context of a user equipment (UE) and a second context of the UE at a network entity; and
means for combining procedures related to the first and the second contexts when the first context and the second context are linked.

20. The apparatus of claim 19, wherein the first context and the second context are associated with different international mobile subscriber identities (IMSIs), and wherein the link between the first context and the second context is determined when the first context and the second context are associated with a common international mobile equipment identity (IMEI) of the UE.

21. The apparatus of claim 20, wherein the means for combining procedures related to the first and the second contexts synchronizes procedures related to the different IMSIs.

22. The apparatus of claim 20, wherein the means for combining procedures related to the first and the second contexts is configured to:
perform a device-specific procedure in relation to the first context;
refrain from performing the device-specific procedure in relation to the second context; and
propagate a result of the device-specific procedure between the first and second contexts.

23. The apparatus of claim 20, wherein the procedures related to the first and the second contexts include at least one radio resource procedure.

24. The apparatus of claim 23, wherein the at least one radio resource procedure comprises one or more of a UE capability exchange, a handover of the UE between base stations, a tracking area update procedure, a location area update procedure, and a routing area update procedure.

25. The apparatus of claim 23, wherein the means for combining procedures related to the first and the second contexts is configured to initiate a measurement reporting procedure adapted to minimize a drive tests procedure at the UE.

26. The apparatus of claim 19, wherein the means for combining procedures causes the UE to monitor pages corresponding to both the first context and the second context during a single paging occasion in a discontinuous reception (DRX) cycle.

27. The apparatus of claim 19, further comprising means for coordinating assignment of resources for the first context and the second context, wherein the resources are assigned based on a power constraint of the UE.

28. The apparatus of claim 19, wherein the means for determining the link exchanges information with at least one other network entity in an attach or registration update message, the information relating the first context and the second context to a unique identifier of the UE.

29. The apparatus of claim 19, wherein the network entity is configured to perform mobility management functions or radio resource management functions for the UE.

30. An apparatus for wireless communication, comprising:
a communications interface; and
a processing circuit configured to:
determine a link between a first context of a user equipment (UE) and a second context of the UE at a network entity; and
combine procedures related to the first and the second contexts when the first context and the second context are linked.

31. The apparatus of claim 30, wherein the first context and the second context are associated with different international mobile subscriber identities (IMSIs), and wherein the processing circuit determines the link between the first context and the second context when the first context and the second context are associated with a common international mobile equipment identity (IMEI) of the UE.

32. The apparatus of claim 31, wherein the processing circuit is configured to synchronize procedures related to the different IMSIs.

33. The apparatus of claim 31, wherein the processing circuit is configured to combine procedures related to the first and the second contexts by:
performing a device-specific procedure in relation to the first context;
refraining from performing the device-specific procedure in relation to the second context; and
propagating a result of the device-specific procedure between the first and second contexts.

34. The apparatus of claim 31, wherein the procedures include at least one of a UE capability exchange, a handover of the UE between base stations, a tracking area update procedure, a location area update procedure and a routing area update procedure.

35. The apparatus of claim 31, wherein the processing circuit is configured to combine procedures related to the first and the second contexts by initiating a measurement reporting procedure adapted to minimize a drive tests procedure at the UE.

36. The apparatus of claim 30, wherein the processing circuit is configured to cause the UE to monitor pages corresponding to both the first context and the second context during a single paging occasion in a discontinuous reception (DRX) cycle.

37. The apparatus of claim 30, wherein the processing circuit is configured to coordinate assignment of resources for the first context and the second context, wherein the resources are assigned based on a power constraint of the UE.

38. The apparatus of claim 30, wherein the processing circuit is configured to determine whether the first context and the second context are linked based on information transmitted in an attach or registration update message between the network entity and another network entity.

39. The apparatus of claim 30, wherein the network entity comprises a home subscriber server or a home location register.

40. The apparatus of claim 30, wherein the network entity is configured to perform mobility management functions or radio resource management functions for the UE.

41. A processor-readable storage medium having one or more instructions which, when executed by at least one processing circuit, cause the at least one processing circuit to:
determine a link between a first context of a user equipment (UE) and a second context of the UE at a network entity; and
combine procedures related to the first and the second contexts when the first context and the second context are linked.

42. The processor-readable storage medium of claim 41, wherein the first context and the second context are associated with different international mobile subscriber identities (IMSIs), and wherein the link between the first context and the second context is determined when the first context and the second context are associated with a common international mobile equipment identity (IMEI) of the UE.

43. The processor-readable storage medium of claim 42, wherein combining procedures related to the first and the second contexts includes synchronizing procedures related to the different IMSIs.

44. The processor-readable storage medium of claim 42, wherein combining procedures related to the first and the second contexts includes:
performing a device-specific procedure in relation to the first context; and
refraining from performing the device-specific procedure in relation to the second context, wherein a result of the device-specific procedure is propagated between the first and second contexts.

45. A user equipment (UE) configured to maintain connections related to multiple subscriptions, the UE comprising:
a modem configured to communicate with a radio access network; and
a processing system configured to:
maintain a first wireless communications link corresponding to a first subscription and a second wireless communications link corresponding to a second subscription;
refrain from performing a first radio resource procedure in relation to the first subscription after performing a similar radio resource procedure in relation to the second subscription; and
synchronize performance of a second radio resource procedure in relation to the first subscription with performance of the second radio resource procedure in relation to the second subscription.

46. The UE of claim 45, wherein the first subscription and the second subscription are associated with a common international mobile equipment identity (IMEI) of the UE and different international mobile subscriber identities (IMSIs) and wherein contexts corresponding to the different IMSIs are linked based on the IMEI.

47. The UE of claim 46, wherein the first radio resource procedure comprises one or more of a UE capability exchange, a handover of the UE between base stations and a measurement reporting procedure.

48. The UE of claim 47, wherein the measurement reporting procedure relates to a drive tests procedure.

49. The UE of claim 46, wherein the first radio resource procedure comprises one or more of a tracking area update procedure, a location area update procedure and a routing area update procedure.

50. The UE of claim 46, wherein the performance of the second radio resource procedure is synchronized by monitoring pages corresponding to both the first subscription and the second subscription during a single paging occasion in a discontinuous reception cycle.

51. A method for maintaining connections related to multiple subscriptions, comprising:
maintaining a first wireless communications link corresponding to a first subscription and a second wireless communications link corresponding to a second subscription;
refraining from performing a first radio resource procedure in relation to the first subscription after performing a similar radio resource procedure in relation to the second subscription; and
synchronizing performance of a second radio resource procedure in relation to the first subscription with performance of the second radio resource procedure in relation to the second subscription.

52. The method of claim 51, wherein the first subscription and the second subscription are associated with a common international mobile equipment identity (IMEI) and different international mobile subscriber identities (IMSIs) and wherein contexts corresponding to the different IMSIs are linked based on the IMEI.

53. The method of claim 52, wherein the first radio resource procedure comprises one or more of a UE capability exchange, a handover of the UE between base stations and a measurement reporting procedure.

54. The method of claim 53, wherein the measurement reporting procedure relates to a drive tests procedure.

55. The method of claim 52, wherein the first radio resource procedure comprises one or more of a tracking area update procedure, a location area update procedure and a routing area update procedure.

56. The method of claim 52, wherein the performance of the second radio resource procedure is synchronized by monitoring pages corresponding to both the first subscription and the second subscription during a single paging occasion in a discontinuous reception cycle.

57. A user equipment (UE) configured to maintain connections related to multiple subscriptions, comprising:
means for maintaining first and second wireless communications links corresponding to first and second subscriptions, respectively; and
means for performing radio resource procedures,
wherein the means for performing radio resource procedures is configured to refrain from performing a first radio resource procedure in relation to the first subscription after performing a similar radio resource procedure in relation to the second subscription,
wherein the means for performing radio resource procedures is configured to synchronize performance of a second radio resource procedure in relation to the first subscription with performance of the second radio resource procedure in relation to the second subscription.

58. The UE of claim 57, wherein the first subscription and the second subscription are associated with a common international mobile equipment identity (IMEI) and different international mobile subscriber identities (IMSIs), and wherein contexts corresponding to the different IMSIs are linked based on the IMEI.

59. The UE of claim 58, wherein the first radio resource procedure comprises one or more of a UE capability exchange, a handover of the UE between base stations, a measurement reporting procedure, a tracking area update procedure, a location area update procedure and a routing area update procedure.

60. The UE of claim 58, wherein the means for performing radio resource procedures is configured to monitor pages corresponding to both the first subscription and the second subscription during a single paging occasion in a discontinuous reception cycle.

61. A non-transitory processor-readable storage medium having one or more instructions which, when executed by at least one processing circuit, cause the at least one processing circuit to:
maintain a first wireless communications link corresponding to a first subscription and a second wireless communications link corresponding to a second subscription;
refrain from performing a first radio resource procedure in relation to the first subscription after performing a similar radio resource procedure in relation to the second subscription; and
synchronize performance of a second radio resource procedure in relation to the first subscription with performance of the second radio resource procedure in relation to the second subscription,
wherein the first subscription and the second subscription are associated with a common international mobile equipment identity (IMEI) and different international mobile subscriber identities (IMSIs) and wherein contexts corresponding to the different IMSIs are linked based on the IMEI.

62. The non-transitory processor-readable storage medium of claim 61, wherein the first subscription and the second subscription are associated with a common international mobile equipment identity (IMEI) and different international mobile subscriber identities (IMSIs), and wherein contexts corresponding to the different IMSIs are linked based on the IMEI.

63. The non-transitory processor-readable storage medium of claim 62, wherein the first radio resource procedure comprises one or more of a UE capability exchange, a handover of the UE between base stations, a measurement reporting procedure, a tracking area update procedure, a location area update procedure and a routing area update procedure.

64. The non-transitory processor-readable storage medium of claim 62, wherein one or more instructions include instructions that cause the at least one processing circuit to monitor pages corresponding to both the first subscription and the second subscription during a single paging occasion in a discontinuous reception cycle.
